(19) United States
(12) Patent Application Publication
(10) Pub. No.: US 2005/0225696 A1
(43) Pub. Date: Oct. 13, 2005

(54) Liquid crystal display device and electronic apparatus

(76) Inventor: Toshiharu Matsushima, Suwa (JP)

Correspondence Address: HARNESS, DICKEY & PIERCE, P.L.C., P.O. BOX 828, BLOOMFIELD HILLS, MI, 48303, US

(21) Appl. No.: 11/098,121

(22) Filed: Apr. 4, 2005

(30) Foreign Application Priority Data
Apr. 8, 2004 (JP) 2004-114120

(51) Int. Cl. G02F 1/1335

(52) U.S. Cl. 349/98

(57) ABSTRACT

A liquid crystal display device includes a birefringence element provided between a ¼-wave plate and a linear polarizing plate of at least one of a first and second circular polarizing plates. The birefringence element satisfies one of the relationships: nz>nx or nz>ny, wherein nz is a refractive index of the birefringence element in a thickness-wise direction of the birefringence element; and nx and ny are refractive indexes of the birefringence element in azimuth directions in the plane of the birefringence element.

### BACKGROUND

1. Technical Field

The present invention relates to a liquid crystal display device and an electronic apparatus.

2. Related Art

As liquid crystal display devices, transflective liquid crystal display devices which include a reflective mode and a transmissive mode are known. As such a transflective liquid crystal display device, a liquid crystal display device has been suggested in which a liquid crystal layer is interposed between an upper substrate and a lower substrate, and a reflecting layer with a light transmissive window in a metal layer made of aluminum is provided on the internal surface of the lower substrate so as to function as a transflective plate. (Moreover, in the present specification, a surface of each of the substrates facing the liquid crystal layer is referred to as the internal surface and a surface of each of the substrates opposite to the liquid crystal layer is referred to as the external surface). In this case, in the reflective mode, external light incident from the upper substrate is reflected from the reflecting layer on the internal surface of the lower substrate after passing through the liquid crystal layer, then passes through the liquid crystal layer again and is emitted from the upper substrate to contribute to display. On the other hand, in the transmissive mode, light incident from a backlight incident from the lower substrate passes through the liquid crystal layer through the window of the reflecting layer and is emitted from the upper substrate to the outside to contribute to display. Therefore, in the formation region of the reflecting layer, the region of the reflecting layer with the window is the transmissive display region and the other region is the reflective display region.

However, in the related-art transflective liquid crystal display devices, there is a problem in that the viewing angle in the transmissive display tends to be narrow. That is, because the transflective plate is provided on the internal surface of a liquid crystal cell to avoid parallax problems, reflective display must be performed with only the one polarizing plate provided on the observer side, which limits the degree of freedom of optical design.

Japanese Unexamined Patent Application Publication Nos. 2002-40428 and 5-113561 and “Development of transflective LCD for high contrast and wide viewing angle by using homeotropic alignment”, M. Jisaki et al., Asia Display/IDW'01, P. 133-136 (2001) disclose liquid crystal display devices that use a vertical alignment liquid crystal for the purpose of solving the above-described problem. In order to allow circularly polarized light to be incident on the liquid crystal layer, a circular polarizing plate having a linear polarizing plate which is combined with a ¼-wave plate (a retardation plate) is provided on the external surface of the substrate. The characteristics of the circular polarizing plate have a large influence on the visual angle characteristics.

### SUMMARY

However, these publications do not provide sufficiently detailed descriptions about the circular polarizing plate for defining the specific conditions and there is a case in which the contrast ratio deteriorates according to the visual angle. For example, when the above-described structure is viewed from an oblique angle, some dark display areas (i.e. areas that should be displayed “black”) appear brighter and brighter as the viewing angle is increased. This phenomenon is referred to as “light leakage”. The contrast ratio is in such dark display areas is insufficient.

Note that the above-described problems are not limited to transflective liquid crystal display devices. The problems are also common to transmissive liquid crystal display device. Further, the problems are not limited to the vertical alignment type liquid crystal displays, but are also common to twisted nematic (TN) and other types of liquid crystal display devices.

An advantage of the present invention provides a liquid crystal display device which can prevent light leakage when the display is viewed from an oblique direction that can occur when a circular polarizing plate is used and to provide an electronic apparatus having the liquid crystal display device.

According to one aspect of the present invention, a liquid crystal display device has a liquid crystal layer interposed between a pair of substrates. A circular polarizing plate is provided at an external surface of each the substrates. Each circular polarizing plate includes a linear polarizing plate and a ¼-wave plate. The ¼-wave plate having a phase difference of about ¼ the wavelength of incident light. Further, a birefringence element is provided between the ¼-wave plate and the linear polarizing plate of one of the two circular polarizing plates. The birefringence element satisfies the relationship:
nz>nx or nz>ny,
wherein nz is a refractive index of the birefringence element in a thickness-wise direction of the birefringence element; and
nx and ny are refractive indexes of the birefringence element in azimuth directions in the plane of the birefringence element.

The inventor of the present invention noted that the problems relating to light leakage and the subsequent poor contrast described above cannot be solved only by considering the arrangement of the circular polarizing plate or the like, and so believe that the problems are attributable to the visual angle characteristics of the circular polarizing plate. To solve the problems, one aspect of the invention uses a birefringence element to compensate the phase difference in the plane direction of the circular polarizing plates.

FIG. 9B is a diagram schematically showing the configuration of a related-art liquid crystal display device. For facilitating description, FIG. 9B shows a structure wherein the liquid crystal panel is removed from the liquid crystal display device, that is, only the circular polarizing plate or birefringence element is derived from the liquid crystal display device is shown. According to this configuration, upper and lower circular polarizing plates are perpendicular to each other and are configured such that the black display is performed in a front view.

FIG. 9A shows equi-luminance curves of black display of the display of FIG. 9B, in particular, equi-luminance curves of black display at coordinates having an azimuth of from 0° to 360° and a polar angle of from 0° (the normal direction of the panel) to 80° of the configurations shown in FIGS. 9B.

FIGS. 10A and 10B are drawings similar to FIGS. 9A and 9B, respectively, for explaining the operation of a birefringence element according to an aspect of the present invention. Further, in FIG. 9A and FIG. 10A, scales of the equi-luminance curves are equal to each other.

As shown in FIG. 9A, in the related-art liquid crystal display device, the central region appears darker as indicated by a net-hatched region D and appears brighter in the upper right, upper left, lower right, and lower left corners as indicated by a point-hatched region B. On the other hand, as shown in FIG. 10A, the top, bottom, left, and right regions of the liquid crystal display device according to an aspect of the present invention appear brighter as indicated by a point-hatched region B′. Because the brightness of the region B′ is smaller than that of the region B, it can be seen that the contrast is drastically improved. The birefringence element used in this particular simulation has thickness-wise direction retardation (=the refractive index (nz−ny)×the thickness d) of 140 nm. However, the inventor confirmed that the same tendency appears at different values of refractive index nz as long as the refractive index nz satisfies the above-described condition.

According to the liquid crystal display device of the present invention, it is preferable that a slow axis of the birefringence element be substantially parallel to an absorbing axis of the linear polarizing plate. According to this configuration, a display without light leakage in any direction can be achieved.

Further, when nx>ny, Δn=nz−ny, and the thickness of the birefringence element is d, the birefringence element satisfies the condition 80 nm≦Δn·d≦180 nm. The inventor considered the refractive index anisotropy (Δn) of the birefringence element and simulated how the brightness of the black display changes as seen from an oblique direction when Δn·d is changed in various manners (the simulation result is described in detail later). As a result, the inventor discovered that when the Δn·d is in the above-described range, light leakage is sufficiently suppressed in the oblique direction. In particular, when the Δn·d is set to about 140 nm, the display without the generation of the light leakage can be achieved when seen from all angles.

The present invention can be applied to a transflective liquid crystal display device wherein each dot region has a transmissive display region that performs transmissive display and a reflective display region that performs reflective display. According to this configuration, it is possible to achieve a liquid crystal display device which has superior visibility and a wide viewing angle irregardless of the brightness in the environment of use.

An electronic apparatus of the present invention has the liquid crystal display device according to the present invention. According to this configuration, it is possible to achieve an electronic apparatus including a liquid crystal display unit having a wide viewing angle.

### BRIEF DESCRIPTION OF THE DRAWINGS

The invention will be described with reference to the accompanying drawings, wherein like numbers reference like elements, and wherein:

FIG. 1 is a cross-sectional view schematically showing a liquid crystal display device according to an embodiment;

FIG. 2 is an explanatory view showing refractive index anisotropy of a birefringence element;

FIG. 3 is a diagram showing an equi-luminance curve of a liquid crystal display device according to a comparative example;

FIG. 4 is a diagram showing an equi-luminance curve of a liquid crystal display device according to a first embodiment;

FIG. 5 is a diagram showing an equi-luminance curve of a liquid crystal display device according to a second embodiment;

FIG. 6 is a diagram showing an equi-luminance curve of a liquid crystal display device according to a third embodiment;

FIG. 7 is a graph in which the luminance of the black display is plotted with respect to the polar angle in the liquid crystal display device according to the third embodiment;

FIG. 8 is a diagram showing an example of an electronic apparatus;

FIGS. 9A and 9B are diagrams for explaining the operation of a related-art birefringence element; and

FIGS. 10A and 10B are diagrams for explaining the operation of a birefringence element according to an aspect of the present invention.

### DESCRIPTION OF THE EMBODIMENTS

Embodiments of the present invention will now be described with reference to the accompanying drawings. FIG. 1 is a partial cross-sectional view which shows enlarged view of a pixel portion of an active matrix type transflective liquid crystal display device, as an example of a liquid crystal display device of the present invention.

A liquid crystal display device 100 of the present embodiment includes a plurality of pixel electrodes 13 formed on an array substrate 10. The pixel electrodes 13 are arranged in a matrix and are rectangular in plan view (not shown). Further, data lines and scanning lines are provided along boundaries between the pixel electrodes 13 and are arranged to surround each pixel electrode 13. The data lines and the scanning lines define regions each corresponding to a single dot region wherein independent display control is possible. The dot regions are arranged in a matrix.

In the liquid crystal display device 100 shown in FIG. 1, a liquid crystal layer 50 made of a negative dielectric anisotropy liquid crystal material having an initial vertical alignment state is interposed between the array substrate 10 and a counter substrate 20 arranged opposite to the array substrate 10, and a backlight 60 is provided on the external surface of the array substrate 10. The array substrate 10 includes a substrate main body 10A, a reflecting layer 11, and an insulating film 19. The substrate main body 10A is made of a light transmissive material such as quartz, glass or the like. The reflecting layer 11 is made of a metal layer, such as aluminum, silver or the like, having high reflectance. The reflecting layer 11 is partially formed over the main body 10A with the insulating film 19 interposed therebetween. A formation region of the reflecting layer 11 serves as a reflective display region 30 and a non-formation region of the reflecting layer 11, that is, the inside of an opening of the reflecting layer 11 serves as a transmissive display region 40. In this way, the liquid crystal display device 100 according to the present embodiment is a vertical alignment type liquid crystal display device which has a vertical alignment type liquid crystal layer 50 and can also be a transflective liquid crystal display device which is capable of implementing both reflective display and transmissive display.

The insulating film 19 formed on the substrate main body 10A has an uneven surface and also the reflecting layer 11 has an uneven surface corresponding to the uneven surface of the insulating film 19. Since reflected light is scattered by the uneven surface, the reflection from the outside is prevented, and thus the display with wide viewing angle can be implemented. In addition, on the reflecting layer 11, the insulating film 12 is formed at a location corresponding to the reflective display region 30. Specifically, the insulating film 12 is selectively formed to be located above the reflecting layer 11, so that the liquid crystal layer 50 has a different thickness in the reflective display region 30 from in the transmissive display region 40 due to the insulating film 12. The insulating film 12 is, for example, made of an organic film such as acrylic resin having a thickness of about 2 to 3 μm. At the boundary between the reflective display region 30 and the transmissive display region 40, the insulating film 12 has an inclined region having an inclined surface. As a result, the insulating film 12 becomes gradually thinner from the thickest portion in the reflective display region 30 and the thinnest portion in the transmissive display region 40. The thickness of a part of the liquid crystal layer 50 not having the insulating film 12 is about 4 to 6 μm. As a result, the thickness of the liquid crystal layer 50 in the reflective display region 30 is about half of the thickness of the liquid crystal layer 50 in the transmissive display region 40.

In this way, the insulating film 12 serves as a liquid crystal layer thickness-adjusting layer that gives the liquid crystal layer 50 a different thickness in the reflective display region 30 from in the transmissive display region 40 due to the film thickness. According to the present embodiment, the edge of the reflecting layer 11 (reflective display region) is substantially aligned with the edge of the flat upper surface of the insulating film 12 and the inclined region of the insulating film 12 is included in the transmissive display region 40. In addition, the pixel electrode 13 and a vertical alignment film (not shown) are formed on the surface of the array substrate 10, which includes the surface of the insulating film 12. The pixel electrode 13 is made of a transparent conductive film such as indium tin oxide (hereinafter, referred to as ITO). The vertical alignment film is made of polyimide. In addition, according to the present embodiment, the reflecting layer 11 and the pixel electrode 13 are separately provided and laminated. However, in the reflective display region 30, the reflecting layer made of the metal film may be used as the pixel electrode.

On the other hand, in the transmissive display region 40, the insulating film 19 is formed on the substrate main body 10A, while the reflecting layer 11 and the insulating film 12 are not formed on the insulating film 19. Specifically, on the insulating film 19, the pixel electrode 13 and the vertical alignment film made of polyimide or the like are formed.

As for the counter substrate 20, color filters 22 are provided on an internal surface of a substrate main body 20A made of a light transmissive material such as glass, quartz or the like. In addition, a black matrix BM is disposed between adjacent color filters 22. On the surface of the color filter 22 facing the liquid crystal layer, a common electrode 23 made of a transparent conductive film such as ITO and a vertical alignment film (not shown) made of polyimide are formed. The common electrode 23 is provided with an opening in the reflective display region 30. The opening induces an oblique electric field that controls the tilt directions of the liquid crystal molecules.

Next, on the external surface of the substrate main body 10A of the array substrate 10, a C plate 15, a ¼-wave plate 16, and a linear polarizing plate 17 are sequentially mounted via an adhesive layer (not shown) as viewed from the substrate main body. In addition, on the external surface of the substrate main body 20A of the counter substrate 20, a C plate 25, a ¼-wave plate 26, a birefringence element 28, and a linear polarizing plate 27 are sequentially mounted via an adhesive layer (not shown) as viewed from the substrate main body.

The phase difference (retardation) of the ¼-wave plates 16 and 26 is about ¼ of the wavelength of incident light. In the present embodiment, a stretched film having a phase difference of 140 nm with respect to incident light having a wavelength of 560 nm is used. The ¼-wave plate 16 is arranged so that its slow axis crosses the absorbing axes of the polarizing plate 17 at an angle of 45°. Similarly, the ¼-wave plate 26 is arranged so that its slow axis crosses absorbing axes of the polarizing plate 27 at an angle of 45°. The ¼-wave plate 16 and the linear polarizing plate 17 constitute a lower circular polarizing plate and the ¼-wave plate 26 and the linear polarizing plate 27 constitute an upper circular polarizing plate. In addition, optical axes of the circular polarizing plates are arranged so as to perform black display at an initial state. Specifically, the absorbing axis of the polarizing plate 17 is orthogonal to the absorbing axis of the polarizing plate 27 and the slow axis of the ¼-wave plate 16 is orthogonal to the slow axis of the ¼-wave plate 26.

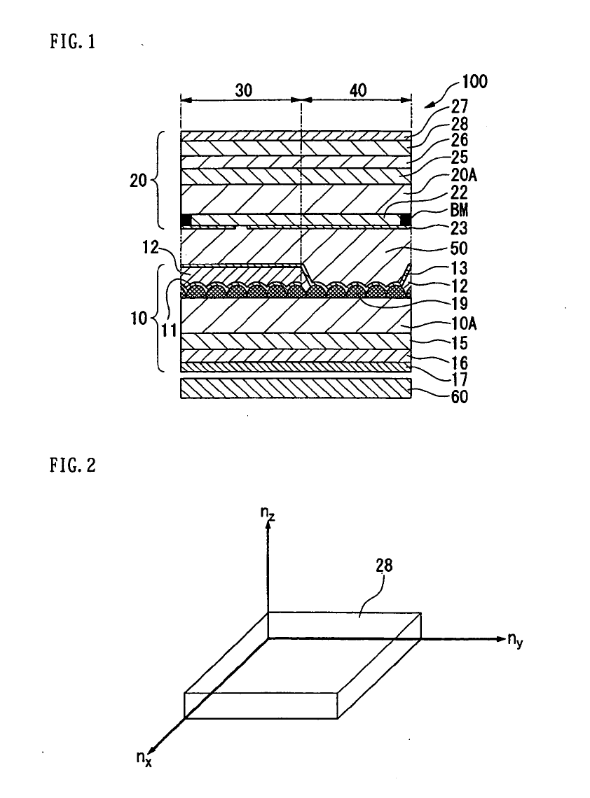

The birefringence element 28 compensates for the visual angle characteristics of the circular polarizing plate (the ¼-wave plate 26 and the linear polarizing plate 27). Further, the birefringence element 28 has a refractive index in its thickness-wise direction that is greater than the smaller of the two refractive indexes in planar directions of the birefringence element 28. Assuming that, as shown in FIG. 2, nx and ny represent the refractive indexes in azimuth directions orthogonal to each other in the plane of the birefringence element 28 and nz represents the refractive index in the thickness-wise direction, then the birefringence element 28 has an optical characteristic that satisfies one of the relationships:
nz>nx or nz>ny

In the present embodiment, for example, nz=nx>ny is set.

Each of the C plates 15 and 25 serves as a retardation film having a phase difference in the thickness-wise direction and has an optical characteristic that the refractive index (nz) in the thickness-wise direction is smaller than the refractive index in the plane (nx, ny; nx=ny). In the present embodiment, when the thickness of each of the C plates 15 and 25 is d, the phase difference value (nz−nx)·d is set to 120 nm.

In addition, the liquid crystal layer 50 is set such that when refractive index anisotropy thereof is Δn and the thickness thereof is d, the phase difference value Δn·d is in a range of from 0.4 to 0.5. Specifically, for example, Δn·d=0.41 is set.

As described above, the birefringence element 28 that compensates the visual angle characteristics of the circular polarizing plate is located between the ¼-wave plate 26 and the linear polarizing plate 27, which constitute the circular polarizing plate. As a result, even when seen from the oblique direction, light leakage is not readily generated, so that a display having high contrast can be implemented.

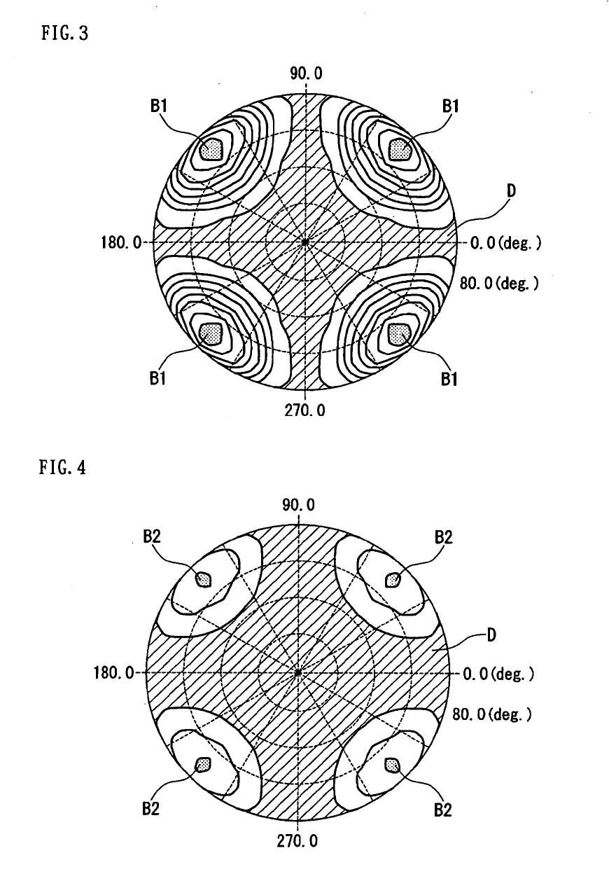

Next, FIGS. 3 to 6 will be described. FIGS. 3 to 6 show results of simulations performed assuming a liquid crystal display device having the basic configuration of the embodiment shown in FIG. 1. FIGS. 3 to 6 show equi-luminance curves of black display at coordinates having an azimuth of from 0° to 360° and a polar angle of from 0° (the normal direction of the panel) to 80°.

FIG. 3 show a simulation for a comparative example having the basic configuration of the embodiment shown in FIG. 1, but without the birefringence element 28. FIG. 3 shows the equi-luminance curve of the black display for the comparative example. In FIG. 3, a part where the black display appears darkest (a net-hatched region indicated by a reference character D) is seen at the central region and parts where the black display appears brighter (a point-hatched region indicated by a reference character B1) are seen at the upper right, upper left, lower right, and lower left corners. In the region B1, the sufficient contrast cannot be ensured.

FIG. 4 is a diagram showing an equi-luminance curve of black display for a first example of the embodiment shown in FIG. 1. In the first example, the slow axis of the birefringence element 28 is arranged to be substantially parallel to a transmitting axis of the upper polarizing plate 27. In FIG. 4, parts where the light leakage is generated (a point-hatched region indicated by a reference character B2) are also seen at the upper right, upper left, lower right, and lower left corners. However, the brightness of the region B2 is smaller than that of the region B1, and thus it can be seen that the contrast is drastically improved.

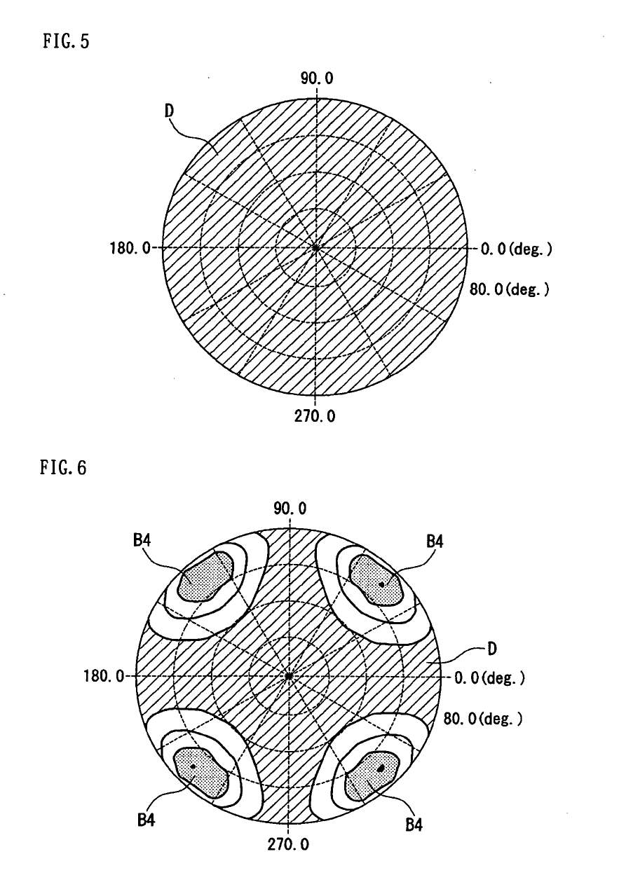

FIG. 5 is a diagram showing an equi-luminance curve of black display for a second example of the embodiment shown in FIG. 1. In the second example, the slow axis of the birefringence element 28 is arranged to be substantially parallel to the absorbing axis of the upper polarizing plate 27. According to this configuration, the display not having the generation of the light leakage can be implemented in all directions, which results in the highest visual angle characteristics.

FIG. 6 is a diagram showing an equi-luminance curve of black display for a third example of the embodiment shown in FIG. 1. In the third example, a film satisfying the condition nz>nx (=ny), instead of the birefringence element 28, is arranged. According to this configuration, the degree of the light leakage (a point-hatched region indicated by a reference character B4) is somewhat high as compared to those of the first and second examples, but the configuration has a considerable improvement effect as compared to that of the comparative example in FIG. 3.

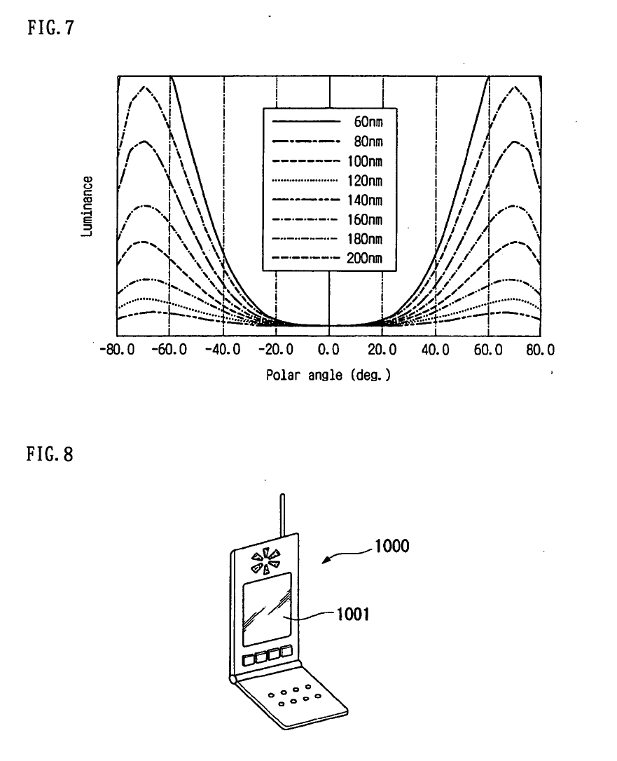

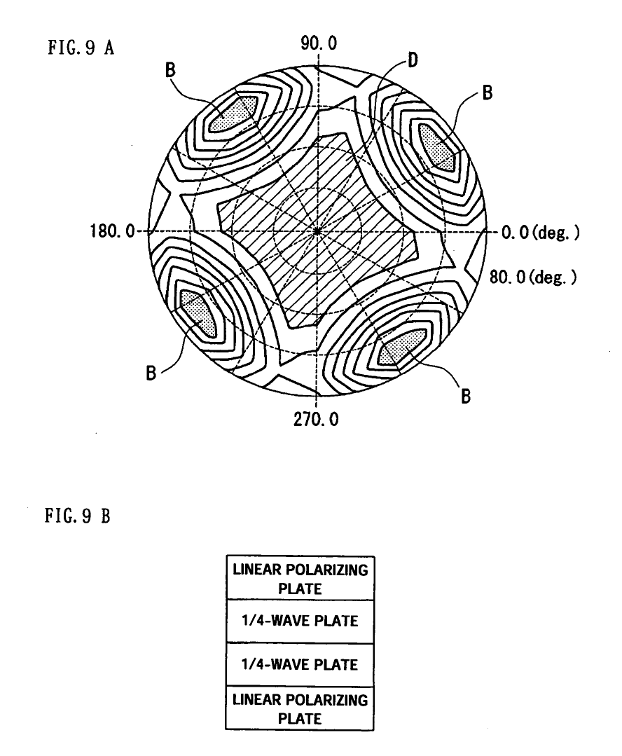

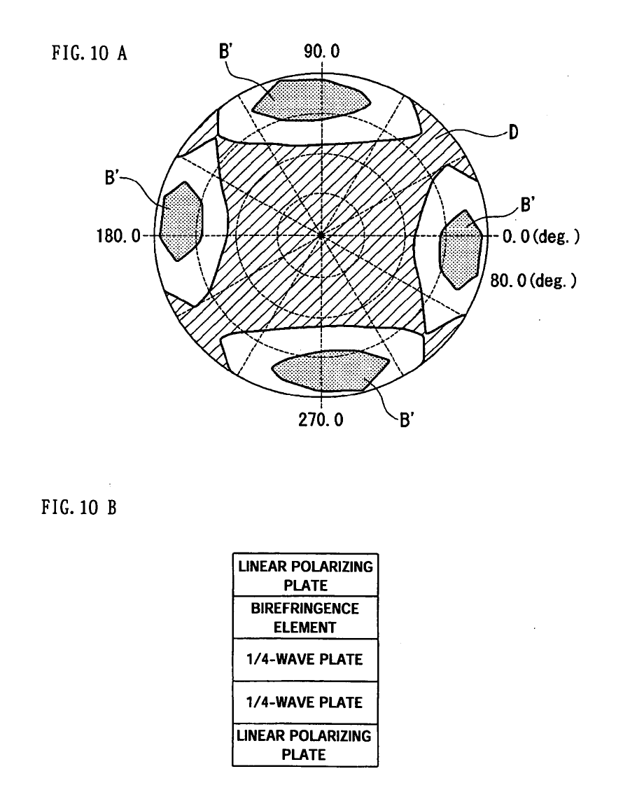

Next, a fourth example will be described. According to the fourth example, the configuration of the third example is used and the value of Δn is changed, while maintaining the relationships of nx>ny, Δn=nz−ny. In this case, “Δn” means “the refractive index anisotropy of the film times the thickness of the film.” The change in brightness in a direction of 45°, which is the angle where light leakage occurs least during a black display, is examined. FIG. 7 shows the simulation results when the value of Δn is changed in a range of from 60 nm to 200 nm at an interval of 20 nm. In FIG. 7, a horizontal axis represents a polar angle and a vertical axis represents the brightness of the black display. As seen from FIG. 7, the light leakage gradually decrease as the phase difference Δn increases. Here, as the phase difference Δn further increases, the light leakage gradually increases. In addition, when the value of Δn is in a range of from 80 nm to 180 nm, the black display is sufficiently suppressed. In particular, when the value of Δn is set to 140 nm, it can be seen that a display having high contrast can be implemented even when seen from all angles.

Next, a specified example of an electronic apparatus having the liquid crystal display device according to the above-described embodiment of the present invention will be described.

FIG. 8 is a perspective view showing an example of a cellular phone. In FIG. 8, reference numeral 1000 denotes a cellular phone main body and reference numeral 1001 denotes a display unit using the above-described liquid crystal display device. When the liquid crystal display device according to the above-described embodiment is used as the display unit of the electronic apparatus such as the cellular phone, the electronic apparatus comprising the liquid crystal display unit having high contrast and the wide viewing angle can be implemented.

In addition, the technical scope of the present invention is not limited to the above-described embodiment, but various modifications can be made within the scope without departing from the spirit the present invention. For example, in the above-described embodiment, the present invention is applied to the transflective liquid crystal display device, but the structure of the liquid crystal display device is not limited thereto. For example, the present invention can be applied to a transmissive liquid crystal display device and a reflective liquid crystal display device. In addition, the display type is not limited to the vertical alignment type, but another type such as a TN type can be adapted. In addition, the specified descriptions of the materials, sizes and shapes of the respective elements can be suitably modified.

1. A liquid crystal display device comprising:
a first substrate;
a second substrate;
a liquid crystal layer interposed between the first and second substrates;
a first circular polarizing plate provided on an external surface of the first substrate and including a linear polarizing plate and a ¼ wave plate, the ¼-wave plate having a phase difference about ¼ of the wavelength of incident light;
a second circular polarizing plate provided on an external surface of the second substrate and including a linear polarizing plate and a ¼ wave plate; and
a birefringence element provided between the ¼-wave plate and the linear polarizing plate of at least one of the first and second circular polarizing plates, the birefringence element satisfying the relationship:
nz>nx or nz>ny,
wherein nz is a refractive index of the birefringence element in a thickness-wise direction of the birefringence element; and
nx and ny are refractive indexes of the birefringence element in azimuth directions in the plane of the birefringence element.

2. The liquid crystal display device according to claim 1, wherein the birefringence element has a slow axis and the linear polarizing plate has an absorbing axis, the slow axis of the birefringence element being substantially parallel to an absorbing axis of the linear polarizing plate.

3. The liquid crystal display device according to claim 1, wherein the birefringence element satisfies the condition nx>ny and further satisfies the relationship:
80 nm≦Δn·d≦180 nm,
wherein Δn=nz−ny and
d is the thickness of the birefringence element.

4. The liquid crystal display device according to claim 1, further comprising an effective display region divided into dot regions, each dot region having a transmissive display region that performs transmissive display and a reflective display region that performs reflective display.
